(19) United States
(12) Patent Application Publication
(10) Pub. No.: US 2015/0310812 A1
(43) Pub. Date: Oct. 29, 2015

(54) SOURCE DRIVER

(71) Applicant: SAMSUNG ELECTRONICS CO., LTD., Suwon-si (KR)

(72) Inventors: Jia-wei CHEN, Dalin Township (TW); Yu-wen CHIOU, Hsinchu City (TW); Yang-wook KIM, Seoul (KR)

(21) Appl. No.: 14/570,034

(22) Filed: Dec. 15, 2014

(30) Foreign Application Priority Data
Apr. 23, 2014 (KR) 10-2014-0048875

(51) Int. Cl. G09G 3/36

(52) U.S. Cl. CPC G09G 3/3607; G09G 3/3614; G09G 3/3696; G09G 2300/0823; G09G 2310/027; G09G 2310/0297; G09G 2310/0291; G09G 2320/0673

(57) ABSTRACT

A source driver includes an output unit and a pre-charge unit. The output unit includes a first output amplifier to output a first output voltage and a second output amplifier to output a second output voltage. A polarity of the second output voltage is opposite to a polarity of the first output voltage. The pre-charge unit pre-charges an input of the first output amplifier and an input of the second output amplifier during a first period, upon a polarity change of the output unit.

### CROSS-REFERENCE TO RELATED APPLICATION

Korean Patent Application No. 10-2014-0048875, filed on Apr. 23, 2014, and entitled, “Source Driver,” is incorporated herein in its entirety by reference.

### BACKGROUND

1. Field

One or more embodiments described herein relate to a source driver.

2. Description of Related Art

A display device is used in electronic appliances such as notebook computers, TVs, and mobile phones. The display device includes a display panel that displays an image and a driver circuit that drives the display panel. The display panel includes a plurality of gate lines arranged in a row direction, a plurality of source lines arranged in a column direction, and a plurality of pixels arranged at intersections of the gate lines and the source lines in a matrix form. The driver circuit includes a gate driver that provides scan signals to the gate lines and a source driver that provides gray scale voltages to the source lines. The source driver converts pixel data of image data to be displayed on the display panel into gamma voltages, which are analog signals, and outputs the gamma voltages to the source lines.

### SUMMARY

In accordance with one embodiment, a source driver includes an output circuit that includes a first output amplifier to output a first output voltage and a second output amplifier to output a second output voltage, a polarity of which is opposite to a polarity of the first output voltage, and a pre-charge circuit to pre-charge an input of the first output amplifier and an input of the second output amplifier during a first period, upon a polarity change of the output circuit.

The source driver may apply gamma voltages corresponding to the first output amplifier and the second output amplifier to the input of the first output amplifier and the input of the second output amplifier during a second period subsequent to the first period.

The source driver may include a digital-to-analog conversion circuit including a first converter to select a first voltage among first gamma voltages based on a first input data and output the first voltage, and a second converter to select a second voltage among second gamma voltages based on a second input data and output the second voltage. A polarity of second gamma voltages is opposite to a polarity of the first gamma voltages. The source driver may further include a multiplexer to selectively provide the first voltage to the input of one of the first output amplifier and the second output amplifier, and selectively provide the second voltage to the input of the other of the first output amplifier and the second output amplifier, in responsive to a polarity signal.

The pre-charge circuit may perform charge sharing by connecting the input of the first output amplifier to the input of the second output amplifier during the first period. The pre-charge circuit may include a switch that is connected between the input of the first output amplifier and the input of the second output amplifier, and may be turned on in response to a pre-charge enable signal during the first period.

The pre-charge circuit may apply a predetermined voltage to the input of the first output amplifier and the input of the second output amplifier during the first period.

The pre-charge circuit may include a first switch having one terminal connected to the input of the first output amplifier and another terminal to which a common voltage is applied, and a second switch having one terminal connected to the input of the second output amplifier and another terminal to which the common voltage is applied. The first switch and the second switch may be turned on in response to a pre-charge enable signal during the first period.

The pre-charge circuit may include a first switch having one terminal connected to the input of the first output amplifier and another terminal to which a first reference voltage is applied, a second switch having one terminal connected to the input of the second output amplifier and another terminal to which the first reference voltage is applied, a third switch having one terminal connected to the input of the first output amplifier and another terminal to which a second reference voltage is applied, and a fourth switch having one terminal connected to the input of the second output amplifier and another terminal to which the second reference voltage is applied. The first switch and the fourth switch may be turned on in response to a first enable signal, and the second switch and the third switch are turned on in response to a second enable signal.

The first enable signal and the second enable signal may be alternately activated during the first period upon the polarity change of the output unit.

The pre-charge circuit may include a first pre-charge circuit to pre-charge the input of the first output amplifier, and a second pre-charge circuit to pre-charge the input of the second output amplifier. The first pre-charge circuit and the second pre-charge circuit may apply a voltage, which is higher or lower than a received input voltage by a threshold voltage, to the input of the first output amplifier and the input of the second output amplifier during the first period, and may apply the received input voltage to the input of the first output amplifier and the input of the second output amplifier during a second period.

The first pre-charge circuit may include an NMOS transistor having a gate connected to an input of the first pre-charge circuit, a drain to which a first power supply voltage is applied and a source connected to an output of the first pre-charge circuit, a PMOS transistor having a gate connected to the input of the first pre-charge circuit, a drain to which a second power supply voltage is applied and a source connected to the output of the first pre-charge circuit, and a switch that is connected between the input and the output of the first pre-charge circuit. One of the PMOS transistor or the NMOS transistor may operate as a source follower during the first period, and the switch may be turned on during the second period to output the received input voltage.

In accordance with another embodiment, a source driver includes a gamma voltage generation circuit that includes at least two resistor strings and generates a plurality of first gamma voltages and a plurality of second gamma voltages, a polarity of which is different from a polarity of the first gamma voltages. The source driver may also include a digital-to-analog conversion circuit to select gamma voltages among the plurality of first gamma voltages and the plurality of second gamma voltages, based on input data and a polarity signal, and to provide the selected gamma voltages to relevant output amplifiers among a plurality of output amplifiers.

The source driver may further include an output circuit including the plurality of output amplifiers that buffer the received gamma voltages and output the buffered gamma voltages to source lines of a display panel. The output circuit may output voltages of different polarities, and a pre-charge circuit may pre-charge inputs of the plurality of output amplifiers upon a polarity change of the output circuit.

The pre-charge circuit may pre-charge the inputs of the plurality of output amplifiers during a first period, and may apply the selected gamma voltages to the inputs of the plurality of output amplifiers during a second period. The pre-charge circuit may connect inputs of at least two output amplifiers that output voltages of different polarities among the plurality of output amplifiers during the first period.

The pre-charge circuit may apply at least one reference voltage to the inputs of the plurality of output amplifiers during the first period. At least one reference voltage may have a voltage level between the plurality of first gamma voltages and the plurality of second gamma voltages.

In accordance with another embodiment, a method of operating a source driver includes generating a plurality of first gamma voltages and a plurality of second gamma voltages, selecting gamma voltages among the plurality of first gamma voltages and the plurality of second gamma voltages based on input data and a polarity signal, pre-charging inputs of a plurality of output amplifiers, and providing the selected gamma voltages to the inputs of the plurality of output amplifiers. A polarity of the plurality of second gamma voltages is opposite to a polarity of the plurality of first gamma voltages.

Pre-charging may include performing charge sharing by connecting inputs of at least two output amplifiers that output voltages of different polarities among the plurality of output amplifiers. Pre-charging may include providing at least one reference voltage to the inputs of the plurality of output amplifiers. Pre-charging may include providing voltages, which are higher or lower than the selected gamma voltages by a threshold voltage, to the inputs of the plurality of output amplifiers.

### BRIEF DESCRIPTION OF THE DRAWINGS

Features will become apparent to those of skill in the art by describing in detail exemplary embodiments with reference to the attached drawings in which:

FIG. 1 illustrates an embodiment of a source driver;

FIG. 2 illustrates another embodiment of a source driver;

FIGS. 3A and 3B are timing diagrams of a pre-charge operation of the source driver according to one embodiment;

FIG. 4A illustrates a modification of the source driver of FIG. 1, and FIG. 4B is a timing diagram of a pre-charge operation of the source driver of FIG. 4A;

FIG. 5A illustrates a modification of the source driver of FIG. 4A, and FIG. 5B is a timing diagram of a pre-charge operation of the source driver of FIG. 5A;

FIG. 6A illustrates an embodiment of a pulse generation circuit, and FIG. 6B is a timing diagram of the operation of the pulse generation circuit of FIG. 6A;

FIG. 7 illustrates a modification of the source driver of FIG. 1;

FIG. 8 is a timing diagram of a pre-charge operation of the source driver of FIG. 7;

FIG. 9 illustrates a modification of the source driver of FIG. 1;

FIG. 10 is a timing diagram of a pre-charge operation of the source driver of FIG. 9;

FIG. 11 illustrates a modification of the source driver of FIG. 1;

FIG. 12 is a timing diagram of a pre-charge operation of the source driver of FIG. 11;

FIG. 13 illustrates an embodiment of a display device;

FIG. 14 illustrates a source driver with a plurality of source driver chips;

FIG. 15 illustrates an embodiment of a display module;

FIG. 16 illustrates an embodiment of a display system; and

FIG. 17 illustrating examples of electronic appliances on which the display devices according to the aforementioned embodiments may be mounted.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

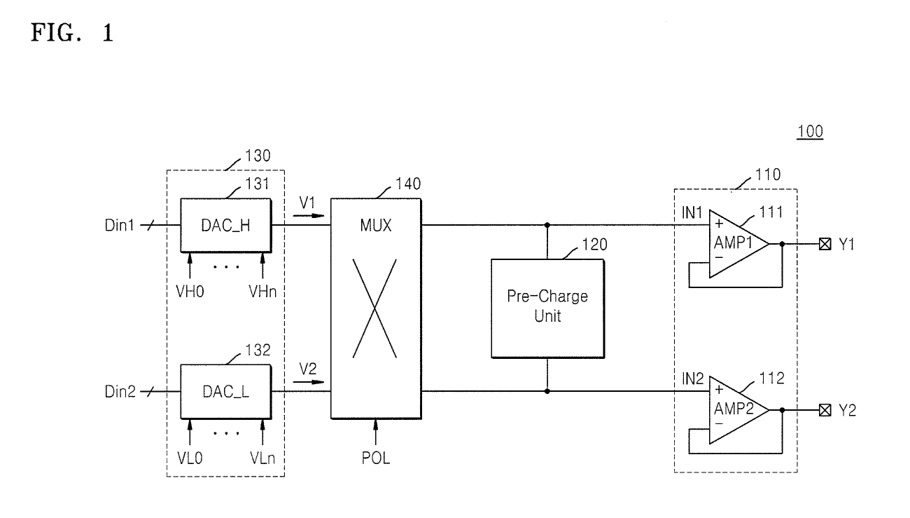

FIG. 1 is a block diagram of a source driver 100 according to an embodiment of the present disclosure. Referring to FIG. 1, the source driver 100 according to the embodiment of the present disclosure may include an output unit 110, a pre-charge unit 120, and a digital-to-analog conversion (DAC) unit 130. The source driver 100 may further include a multiplexer 140.

The output unit 110 may include a plurality of output amplifiers, for example, first and second output amplifiers 111 and 112, and may apply gamma voltages to source lines of a display panel through the first and second output amplifiers 111 and 112. In FIG. 1, the output unit 110 is illustrated as including the first output amplifier 111 and the second output amplifier 112, but this is only for illustrative purposes. The output unit 110 may include more output amplifiers. The number of output amplifiers may be variously changed according to the number of source lines and a driving method.

The output unit 110 may perform voltage buffering or current buffering, based on voltages applied to inputs IN1 and IN2 of the first and second output amplifiers 111 and 112. The output unit 110 may output buffered voltages or currents through output terminals Y1 and Y2 of the first and second output amplifiers 111 and 112 to the source lines. The voltages, which are applied to the inputs IN1 and IN2 of the first and second output amplifiers 111 and 112, may be the gamma voltages obtained by converting pixel data of respective pixels into analog signals. As illustrated in FIG. 1, the first output amplifier 111 and the second output amplifier 112 may be differential amplifiers. In each of the first output amplifier 111 and the second output amplifiers 112, a negative (−) terminal may be connected to an output terminal. Thus, the first output amplifier 111 and the second output amplifier 112 may operate as a current buffer. However, this is only for illustrative purposes and is not limited thereto. The first output amplifier 111 and the second output amplifier 112 may be implemented using various types of amplification circuits.

On the other hand, the first output amplifier 111 and the second output amplifier 112 may output voltages of different polarities, and the polarities of the voltages that are output from the first output amplifier 111 and the second output amplifier 112 may be periodically changed. For example, when the first output amplifier 111 outputs a positive voltage, the second output amplifier 112 may output a negative voltage. Thereafter, when the first output amplifier 111 outputs a negative voltage, the second output amplifier 112 may output a positive voltage.

At this time, the positive voltage and the negative voltage may refer to a voltage having a higher or lower level than that of a voltage that is commonly applied to the display panel, for example, a common voltage. In order to prevent the degradation of the display panel and improve the quality of displayed images, the source driver 100 may switch voltages to be applied to pixels in units of frames and may drive the display panel by using an inversion method of applying voltages of different polarities to adjacent pixels.

Upon a polarity change of the output unit 110, the pre-charge unit 120 may pre-charge the input IN1 of the first output amplifier 111 and the input IN2 of the second output amplifier 112 during a predetermined time period. For example, the pre-charge unit 120 may perform charge sharing by connecting the input IN1 of the first output amplifier 111 to the input IN2 of the second output amplifier 112, or may perform pre-charging by applying predetermined voltages to the input IN1 of the first output amplifier 111 and the input IN2 of the second output amplifier 112.

The DAC unit 130 may convert first and second input data Din1 and Din2 into gamma voltages corresponding to the first and second input data Din1 and Din2, and may output the gamma voltages as a first voltage V1 and a second voltage V2. The first and second input data Din1 and Din2 may be pixel data of the respective pixels. Each of the first and second input data Din1 and Din2 may include a plurality of bits. The first input data Din1 may be pixel data of a pixel driven by the first output amplifier 111 or pixel data of a pixel driven by the second output amplifier 112. The second input data Din2 may be pixel data of a pixel driven by the second output amplifier 112 or pixel data of a pixel driven by the first output amplifier 111.

The DAC unit 130 may include a first converter 131 and a second converter 132 that output the gamma voltages of different polarities. The first converter 131 may receive a plurality of first gamma voltages VH0 to VHn, for example, positive gamma voltages, and may select a single gamma voltage among the plurality of first gamma voltages VH0 to VHn, based on the first input data Din1. The selected gamma voltage may be output as the first voltage V1. The second converter 132 may receive a plurality of second gamma voltages VL0 to VLn, for example, negative gamma voltages, and may select one gamma voltage among the plurality of second gamma voltages VL0 to VLn, based on the second input data Din2. The selected gamma voltage may be output as the second voltage V2.

In FIG. 1, the DAC unit 130 is illustrated as including two converters, namely, the first and second converters 131 and 132, to receive the first and second input data Dint and Din2, and to output the first and second voltages V1 and V2, but this is only for illustrative purposes and is not limited thereto. The DAC unit 130 may receive more input data and include more converters. The number of pieces of the first and second input data Dint and Din2, and the number of converters may be variously changed according to the number of output amplifiers and the driving method.

The source driver 100 may further include the multiplexer 140. In response to a polarity signal POL, the multiplexer 140 may selectively provide the first output amplifier 111 and the second output amplifier 112 with the first voltage V1 and the second voltage V2 that are output from the DAC unit 130. For example, when the polarity signal POL is in a first state, for example, a logic high state, the multiplexer 140 may apply the first voltage V1 to the input IN1 of the first output amplifier 111 and may apply the second voltage V2 to the input IN2 of the second output amplifier 112. When the polarity signal POL is in a second state, for example, a logic low state, the multiplexer 140 may apply the first voltage V1 to the input IN2 of the second output amplifier 112 and may apply the second voltage V2 to the input IN1 of the first output amplifier 111. On the other hand, when the pre-charge unit 120 pre-charges the input IN1 of the first output amplifier 111 and the input IN2 of the second output amplifier 112, the multiplexer 140 may not output the first voltage V1 and the second voltage V2.

As described above, the source driver 100 according to the embodiment of the present disclosure may select gamma voltages of different polarities, for example, the first voltage V1 and the second voltage V2, based on the first and second input data Din1 and Din2, and may output the selected gamma voltages through the first output amplifier 111 and the second output amplifier 112. Upon a polarity change, the pre-charge unit 120 may pre-charge the input IN1 of the first output amplifier 111 and the input IN2 of the second output amplifier 112 during a predetermined time period, thereby reducing a time taken until the input IN1 of the first output amplifier 111 and the input IN2 of the second output amplifier 112 reach desired gamma voltages.

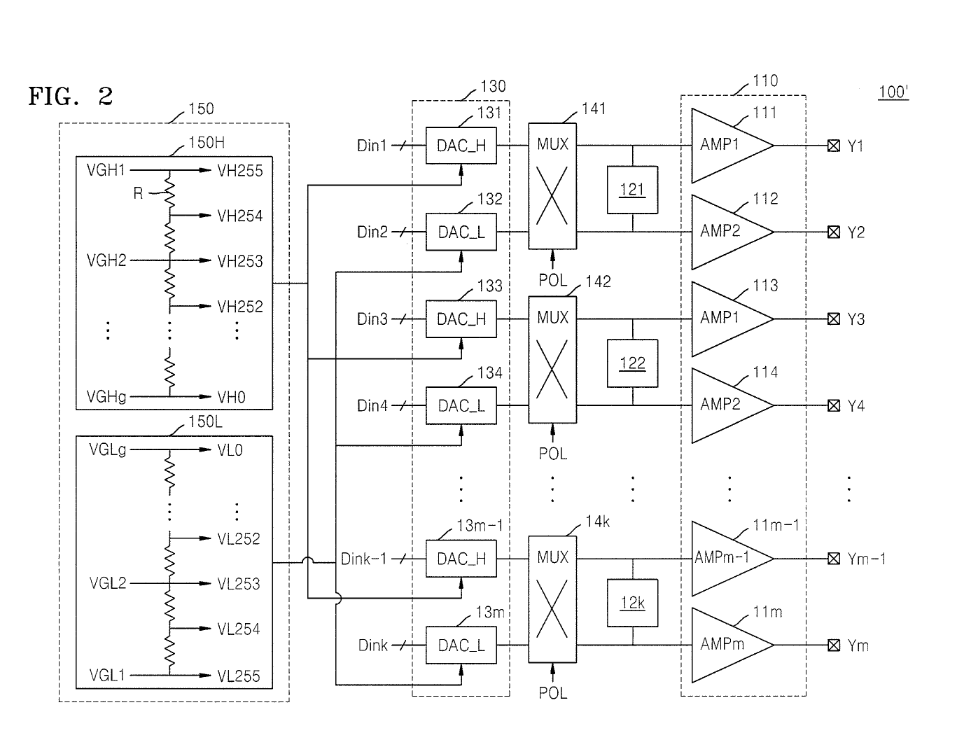

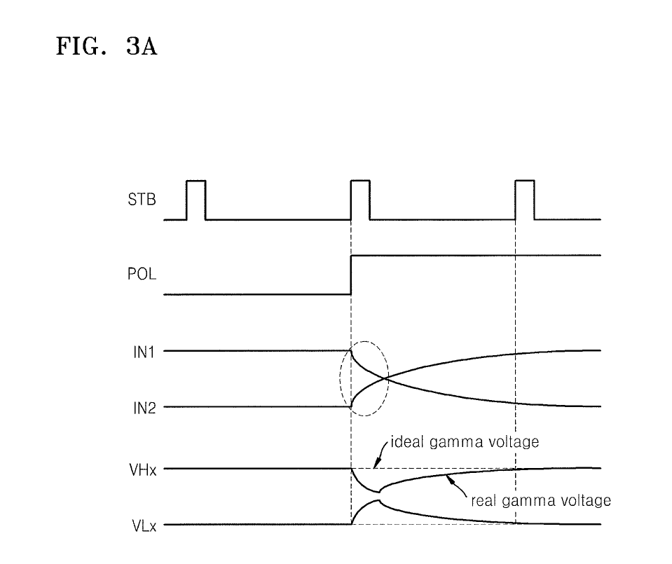

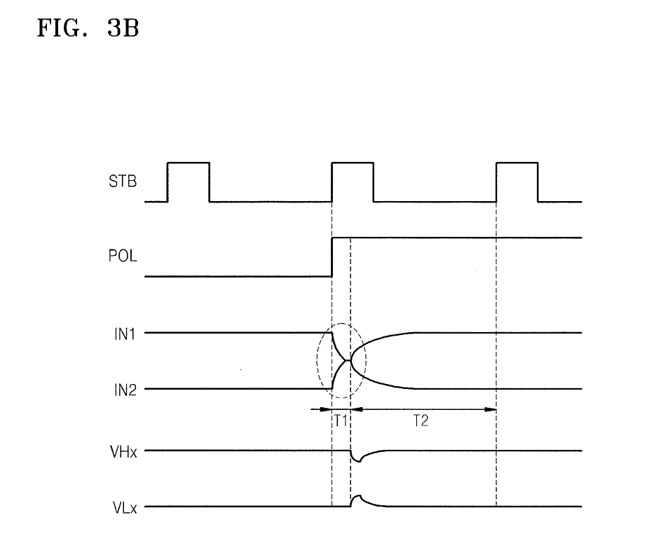

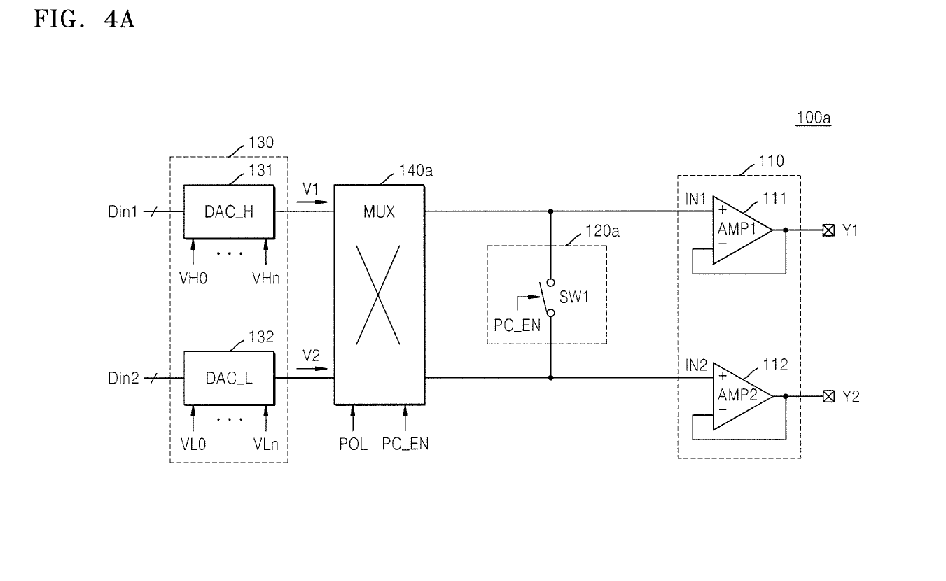

FIG. 2 is a block diagram of a source driver 100′ according to another embodiment of the present disclosure. FIGS. 3A and 3B are timing diagrams of a pre-charge operation of the source driver 100′ of FIG. 2. Referring to FIG. 2, the source driver 100′ may include an output unit 110, a plurality of pre-charge units 121 to 12k, a DAC unit 130, a plurality of multiplexers 141 to 14k, and a gamma voltage generation unit 150.

The output unit 110 may include a plurality of output amplifiers 111 to 11m and may output positive gamma voltages or negative gamma voltages. Upon a polarity change, the plurality of pre-charge units 121 to 12k (where k is a natural number greater than or equal to m) may pre-charge the inputs of the output amplifiers 111 to 11m during a predetermined time period.

The DAC unit 130 may include a plurality of first converters 131, 133, . . . , 13m-1 and a plurality of second converters 132, 134, . . . , 13m, and may convert input data Din1 to Dinm into one of first gamma voltages VH0 to VH255 and second gamma voltages VL0 to VL255.

The plurality of multiplexers 141 to 14k may provide the plurality of output amplifiers 111 to 11m with the gamma voltages that are output from the plurality of first converters 131, 133, . . . , 13m−1 and the plurality of second converters 132, 134, . . . , 13m. The plurality of multiplexers 141 to 14k may change output paths of the gamma voltages in response to a polarity signal POL.

The operations of the output unit 110, the plurality of pre-charge units 121 to 12k, the DAC unit 130, and the plurality of multiplexers 141 to 14k of the source driver 100′ of FIG. 2 are substantially the same as those of the output unit 110, the pre-charge unit 120, the DAC unit 130, and the multiplexer 140 of the source driver 100 of FIG. 1, and thus, a repeated description thereof will be omitted.

The gamma voltage generation unit 150 may include a first resistor string 150H and a second resistor string 150L, and may generate the first gamma voltages VH0 to VH255 and the second gamma voltages VL0 to VL255. For example, the first gamma voltages VH0 to VH255 may be a positive gamma voltage, and the second gamma voltages VL0 to VL255 may be a negative gamma voltage. In FIG. 2, the gamma voltage generation unit 150 is illustrated as generating the 256 first gamma voltages VH0 to VH255 and the 256 second gamma voltages VL0 to VL255, but this is only for illustrative purposes and is not limited thereto. The number of first gamma voltages VH0 to VH255 and the number of second gamma voltages VL0 to VL255 may be variously changed according to a resolution of an image to be displayed on a display panel.

The first resistor string 150H may generate the first gamma voltages VH0 to VH255 by dividing first gamma reference voltages VGH1, . . . , VGHg through a plurality of resistors R. The first gamma voltages VH0 to VH255 may be applied to the plurality of first converters 131, 133, . . . , 13m−1.

The second resistor string 150L may generate the second gamma voltages VL0 to VL255 by dividing second gamma reference voltages VGL1, . . . , VGLg through a plurality of resistors R. The second gamma voltages VL0 to VL255 may be applied to the plurality of second converters 132, 134, . . . , 13m.

On the other hand, upon a polarity change of the output unit 110, the inputs of the output amplifiers 111 to 11m may change from the positive gamma voltage to the negative gamma voltage, or may change from the negative gamma voltage to the positive gamma voltage. Referring to FIGS. 3A and 3B, when the polarity is changed, the state of the polarity signal POL may be changed. In FIGS. 3A and 3B, the state of the polarity signal POL is illustrated as being changed once, but this is only for illustrative purposes.

The state of the polarity signal POL may be changed in synchronization with each rising edge of a standby signal STB of a display device including the source driver 100′. In response to a polarity signal POL, each of the plurality of multiplexers 141 to 14k of FIG. 2 may provide one of the second gamma voltages VL0 to VL255, for example, a negative gamma voltage, to the inputs of the output amplifiers 111 to 11m that receive one of the first gamma voltages VH0 to VH255, for example, a positive gamma voltage.

Also, in response to the polarity signal POL, each of the plurality of multiplexers 141 to 14k of FIG. 2 may provide one of the first gamma voltages VH0 to VH255, for example, a positive gamma voltage, to the inputs of the output amplifiers 111 to 11m that receive one of the second gamma voltages VL0 to VL255, for example, a negative gamma voltage.

For example, the multiplexer 141 may apply one gamma voltage VHx of the first gamma voltages VH0 to VH255 to the input IN1 of the output amplifier 111, and then may apply one second gamma voltage VLx of the second gamma voltages VL0 to VL255 to the input IN1 of the output amplifier 111 according to the state change of the polarity signal POL. Since a parasitic capacitor component exists in the input of the output amplifier 111, the parasitic capacitor component may be charged in order to change the input of the output amplifier 111 from VHx to VLx, the polarity of which is opposite to the polarity of VHx. Since the gamma voltage VLx is generated by the second resistor string 150L of the gamma voltage generation unit 150, current for charging a parasitic capacitor of the output amplifier 111 may flow through the second resistor string 150L.

Similarly, current for charging parasitic capacitors of the inputs of the other output amplifiers 112 to 11m may flow through the first resistor string 150H and the second resistor string 150L. Therefore, as illustrated in FIG. 3A, a voltage drop may occur in the gamma voltages VHx and VLx, and a longer time may be taken until the gamma voltages VHx and VLx are restored to original voltage levels thereof. A gamma setting time of the output amplifiers 111 to 11m may be increased. For example, a longer time may be taken until the inputs IN1 to INm of the output amplifiers 111 to 11m have a desired gamma voltage level.

However, in the source drivers 100 and 100′ according to the embodiments of the present disclosure, the pre-charge units 121 to 12k may pre-charge the inputs IN1 to INm of the output amplifiers 111 to 11m during a predetermined time period, upon a polarity change, thereby reducing the voltage drop of the gamma voltages and the gamma setting time of the output amplifiers 111 to 11m. Referring to FIG. 3B, when the polarity is changed and thus the state of the polarity signal POL is changed, the pre-charge units 121 to 12k may pre-charge the inputs IN1 to INm of the output amplifiers 111 to 11m during a period T1.

For example, the pre-charge units 121 to 12k may perform charge sharing by connecting the inputs IN1 to INm of the output amplifiers 111 to 11m or may apply a predetermined voltage to the inputs IN1 to INm of the output amplifiers 111 to 11m. Since the inputs IN1 to INm of the output amplifiers 111 to 11m are pre-charged, the driving burden of the first resistor string 150H and the second resistor string 150L of the gamma voltage generation unit 150 may be reduced.

Even when the gamma voltages VHx and VLx are applied to the inputs IN1 to INm of the output amplifiers 111 to 11m during a period T2, the voltage drop of the gamma voltages VHx and VLx may be reduced, and a shorter time may be taken until the gamma voltages VHx and VLx are restored to the original voltage levels thereof. A gamma setting time of the output amplifiers 111 to 11m may be reduced. For example, a shorter time may be taken until the inputs IN1 to INm of the output amplifiers 111 to 11m have a desired gamma voltage level.

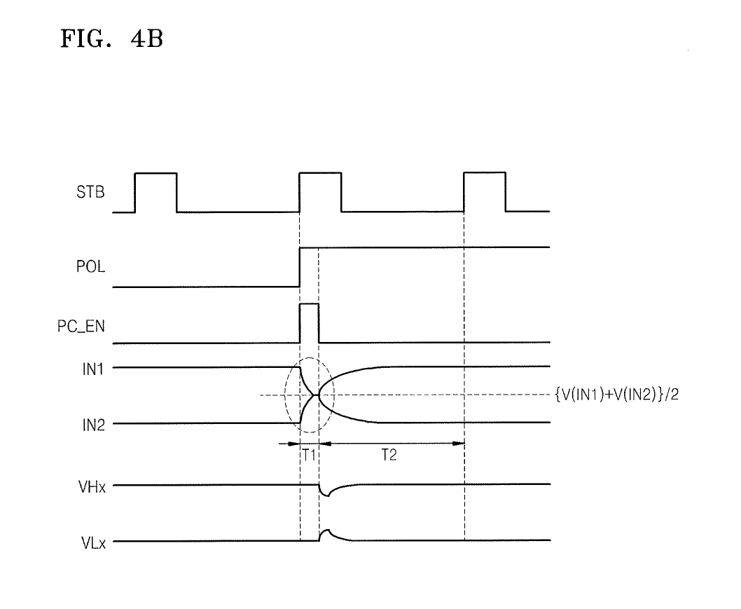

FIG. 4A is a block diagram of a source driver 100a as a modification of the source driver 100 of FIG. 1, and FIG. 4B is a timing diagram of a pre-charge operation of the source driver 100a of FIG. 4A. Referring to FIG. 4A, the source driver 100a may include an output unit 110, a pre-charge unit 120a, a DAC unit 130, and a multiplexer 140a. The operations of the output unit 110 and the DAC unit 130 of the source driver 100a of FIG. 4A are substantially the same as those of the output unit 110 and the DAC unit 130 of the source driver 100 of FIG. 1, and thus, a repeated description thereof will be omitted.

Upon a polarity change, the pre-charge unit 120a may perform charge sharing between the input IN1 of a first output amplifier 111 and the input IN2 of a second output amplifier 112 by connecting the input IN1 of the first output amplifier 111 to the input IN2 of the second output amplifier 112 during a predetermined time period (for example, a pre-charge period).

The pre-charge unit 120a may include a switch SW1 connected between the input IN1 of the first output amplifier 111 and the input IN2 of the second output amplifier 112. The switch SW1 may be implemented using an NMOS transistor, a PMOS transistor, or a transmission gate. The switch SW1 may be turned on in response to a pre-charge enable signal PC_EN in order to electrically connect the input IN1 of the first output amplifier 111 to the input IN2 of the second output amplifier 112.

At this time, the multiplexer 140a may stop operating in response to the pre-charge enable signal PC_EN and output no voltage.

Referring to FIG. 4B, the state of the polarity signal POL may be changed and the pre-charge enable signal PC_EN may be activated during a first period T1. The switch SW1 may be turned on in response to a pre-charge enable signal PC_EN in order to electrically connect the input IN1 of the first output amplifier 111 to the input IN2 of the second output amplifier 112. In this manner, charge sharing may be performed between the input IN1 of the first output amplifier 111 and the input IN2 of the second output amplifier 112. The input IN1 of the first output amplifier 111 and the input IN2 of the second output amplifier 112 may be pre-charged to an average voltage level {V(IN1)+V(IN2)}/2 of input voltages V(IN1) and V(IN2) of the first and second output amplifiers 111 and 112 prior to the first period T1.

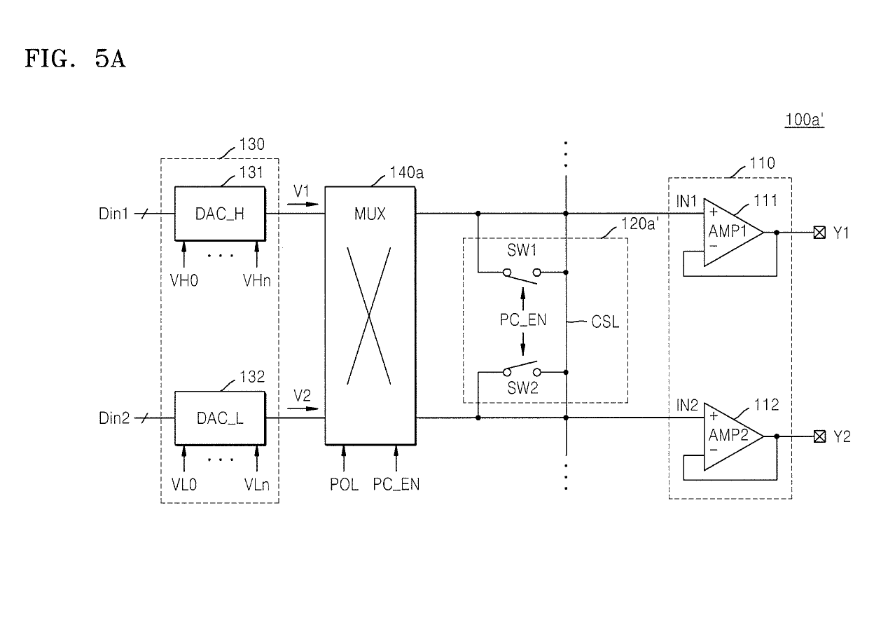

FIG. 5A is a block diagram of a source driver 100a′ as a modification of the source driver 100a of FIG. 4A, and FIG. 5B is a timing diagram of a pre-charge operation of the source driver 100a′ of FIG. 5A.

Referring to FIG. 5A, a pre-charge unit 120a′ may include a charge share line CSL, a first switch SW1, and a second switch SW2. The first switch SW1 has one terminal connected to the input IN1 of the first output amplifier 111 and the other terminal connected to the charge share line CSL, and the second switch SW2 has one terminal connected to the input IN2 of the second output amplifier 112 and the other terminal connected to the charge share line CSL. Referring to FIGS. 5A and 5B, when the state of the polarity signal POL is changed, the first switch SW1 and the second switch SW2 may be turned on in response to a pre-charge enable signal PC_EN in order to electrically connect the inputs IN1 and IN2 of the first and second output amplifiers 111 and 112 to the charge share line CSL during a first period T1. The inputs IN1 and IN2 of the first and second output amplifiers 111 and 112 may be commonly connected to the charge share line CSL, and thus may be charge-shared. For convenience, in FIG. 5A, the output unit 110 is illustrated as including two output amplifiers, for example, the first and second output amplifiers 111 and 112, but this is only for illustrative purposes. The output unit 110 may include more output amplifiers, for example, the output amplifiers 111 to 11m as illustrated in FIG. 2. The inputs of the output amplifiers 111 to 11m may be connected to the charge share line CSL in response to the pre-charge enable signal PC_EN. The inputs of the output amplifiers 111 to 11m may be charge-shared. At this time, the inputs IN1 to INm of the output amplifiers 111 to 11m may be pre-charged to an average voltage level {V(IN1)+V(IN2)+ . . . +V(INm)}/m of the input voltages of the output amplifiers 111 to 11m.

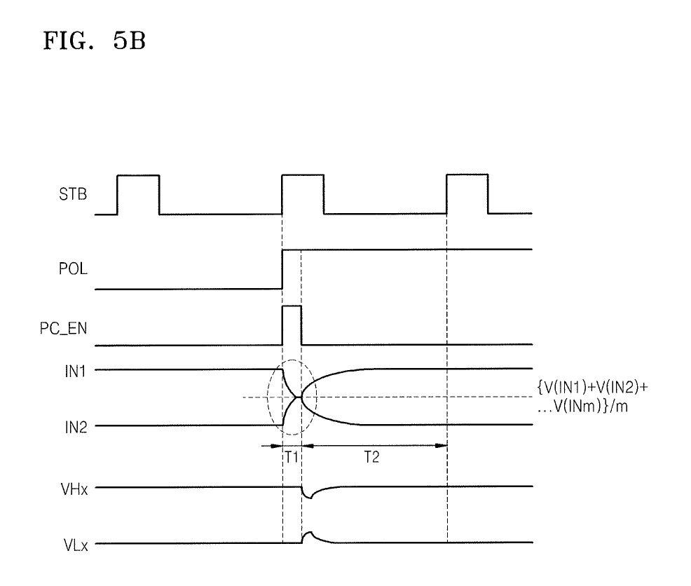

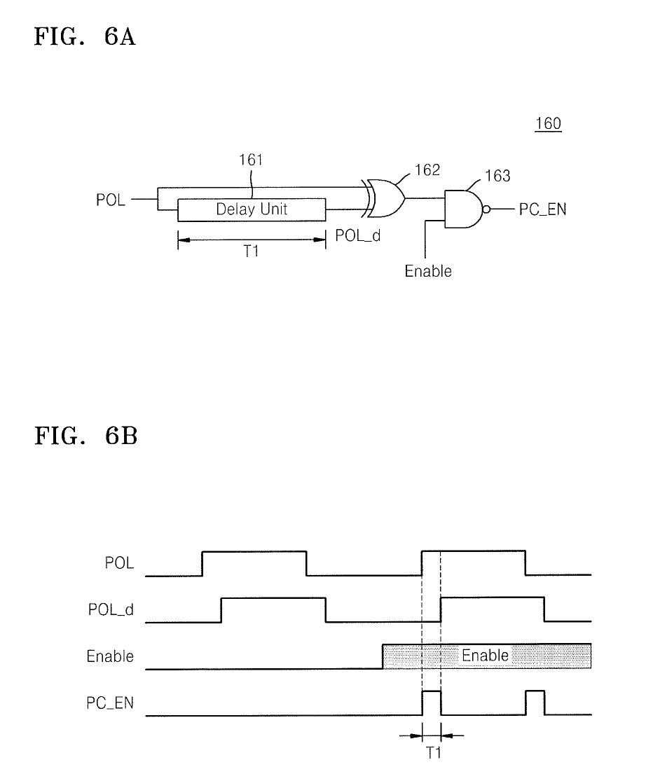

FIG. 6A is a circuit diagram of a pulse generation circuit 160 that generates the pre-charge enable signal PC_EN, and FIG. 6B is a timing diagram of the operation of the pulse generation circuit 160 of FIG. 6A.

Referring to FIG. 6A, the pulse generation circuit 160 may include a delay unit 161, an exclusive OR (XOR) gate 162, and an AND gate 163. The delay unit 161 may be a circuit that includes a plurality of inverters or buffers connected in series.

Referring to FIGS. 6A and 6B, the delay unit 161 may delay the polarity signal POL by the first period T1 and may output a delayed polarity signal POL_d. The XOR gate 162 may output a logic high signal when the states of the polarity signal POL and the delayed polarity signal POL_d are mutually exclusive. When an enable signal Enable is activated to, for example, a logic high state, and the output of the XOR gate 162 is in a logic high state, the pre-charge enable signal PC_EN may be activated.

The circuit of FIG. 6A is merely an example of a pulse generation circuit that generates the pre-charge enable signal PC_EN, and the scope of the present disclosure is not limited thereto. The configuration of the pulse generation circuit 160 may be variously modified as long as the polarity signal POL and the pre-charge enable signal PC_EN have waveforms similar to those illustrated in FIG. 6B.

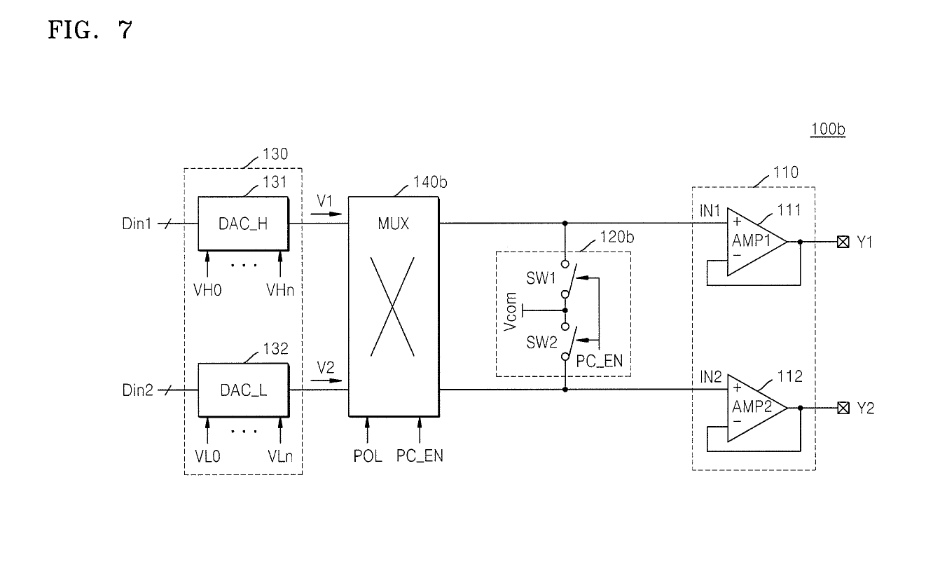

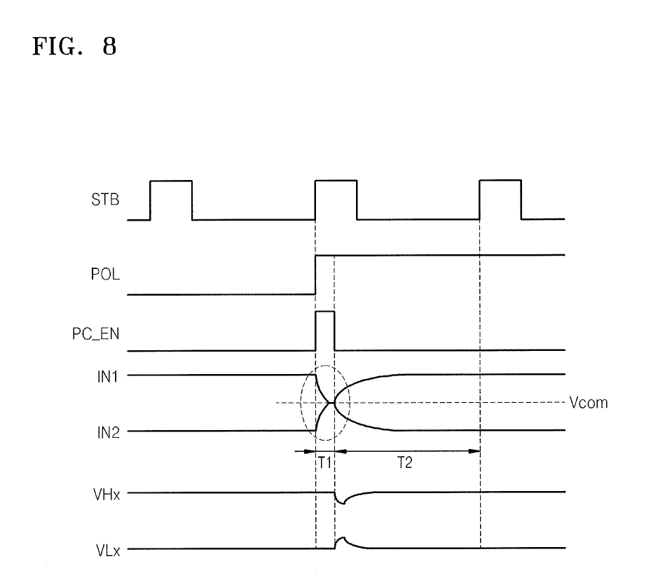

FIG. 7 is a block diagram of a source driver 100b as a modification of implementation of the source driver 100 of FIG. 1, and FIG. 8 is a timing diagram of a pre-charge operation of the source driver 100b of FIG. 7. Referring to FIG. 7, the source driver 100b may include an output unit 110, a pre-charge unit 120b, a DAC unit 130, and a multiplexer 140b. The operations of the output unit 110 and the DAC unit 130 of the source driver 100b of FIG. 7 are substantially the same as those of the output unit 110 and the DAC unit 130 of the source driver 100 of FIG. 1, and thus, a repeated description thereof will be omitted.

Referring to FIGS. 7 and 8, after the state of the polarity signal POL is changed, the pre-charge unit 120b may apply a predetermined voltage, for example, a common voltage Vcom, to the inputs IN1 and IN2 of the first and second output amplifiers 111 and 112 during a first period T1. The common voltage Vcom may be a voltage that is commonly applied to pixels of a display panel (not illustrated), and may have a voltage level between the first gamma voltages VH0 to VHn and the second gamma voltages VL0 to VLn.

The pre-charge unit 120b may include a first switch SW1 and a second switch SW2. The first switch SW1 may have one terminal connected to the input IN1 of the first output amplifier 111 and the other terminal to which the common voltage Vcom is applied. The second switch SW2 may have one terminal connected to the input IN2 of the second output amplifier 112 and the other terminal to which the common voltage Vcom is applied. When the state of the polarity signal POL is changed, the first switch SW1 and the second switch SW2 may be turned on in response to a pre-charge enable signal PC_EN during the first period T1. During the first period T1, the input IN1 of the first output amplifier 111 and the input IN2 of the second output amplifier 112 may be pre-charged to the voltage level of the common voltage Vcom.

During the first period T1, the multiplexer 140b may stop operating in response to the pre-charge enable signal PC_EN and output no voltage. Thereafter, during the second period T2, the gamma voltages VHx and VLx may be output to the input IN1 of the first output amplifier 111 and the input IN2 of the second output amplifier 112.

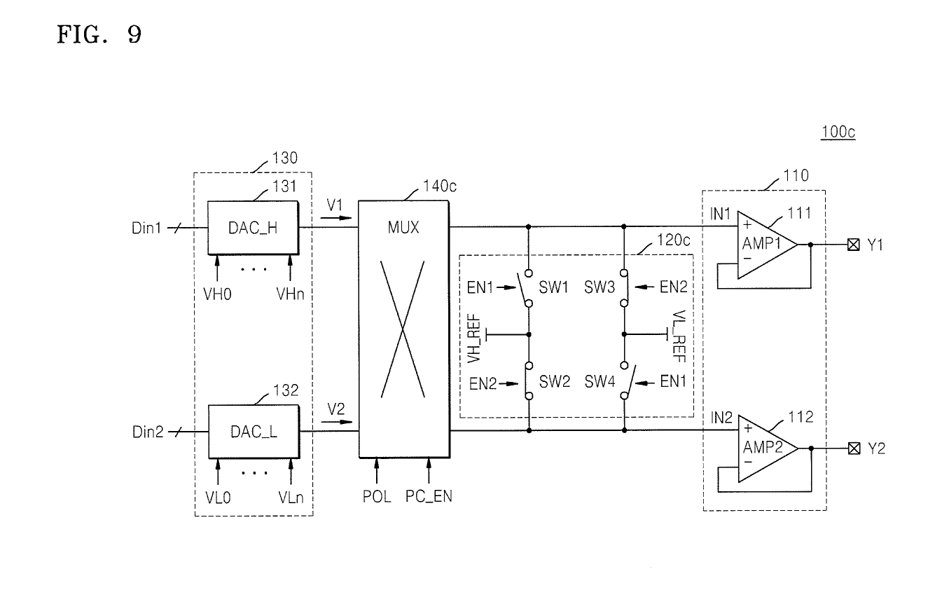

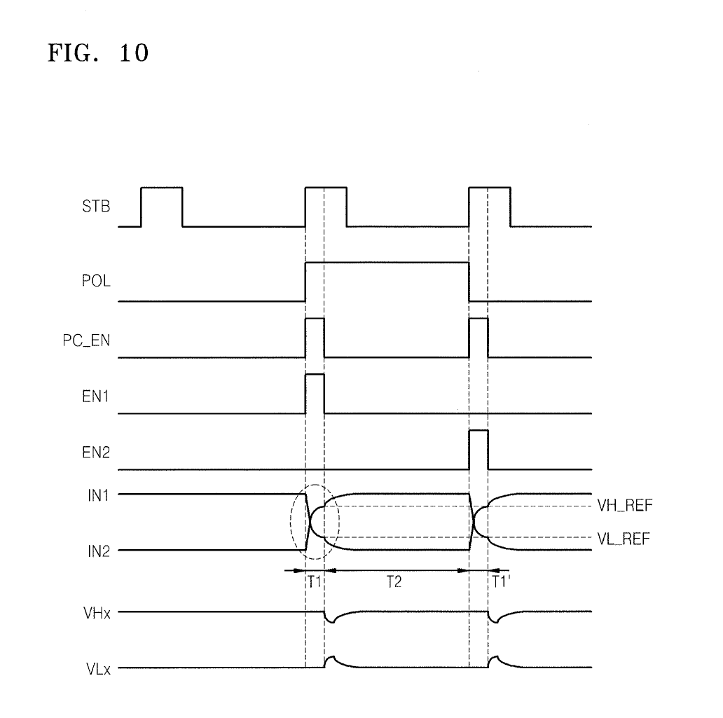

FIG. 9 is a block diagram of a source driver 100c as a modification of the source driver 100 of FIG. 1, and FIG. 10 is a timing diagram of a pre-charge operation of the source driver 100c of FIG. 9. Referring to FIG. 9, the source driver 100c may include an output unit 110, a pre-charge unit 120c, a DAC unit 130, and a multiplexer 140c. The operations of the output unit 110 and the DAC unit 130 of the source driver 100c of FIG. 9 are substantially the same as those of the output unit 110 and the DAC unit 130 of the source driver 100 of FIG. 1, and thus, a repeated description thereof will be omitted.

Referring to FIGS. 9 and 10, after the state of the polarity signal POL is changed, the pre-charge unit 120c may apply one of a first reference voltage VL_REF and a second reference voltage VH_REF, to the inputs IN1 and IN2 of the first and second output amplifiers 111 and 112 during a first period T1. The first reference voltage VH_REF may be higher than the common voltage Vcom of FIG. 8, and the second reference voltage VL_REF may be lower than the common voltage Vcom. The first reference voltage VH_REF may have a voltage level between the first gamma voltage VHn of the highest gray scale and the first gamma voltage VH0 of the lowest gray scale among the first gamma voltages VH0 to VHn. The second reference voltage VL_REF may have a voltage level between the second gamma voltage VLn of the highest gray scale and the second gamma voltage VL0 of the lowest gray scale among the second gamma voltages VL0 to VLn.

The pre-charge unit 120c may include a first switch SW1, a second switch SW2, a third switch SW3, and a fourth switch SW4. The first switch SW1 may have one terminal connected to the input IN1 of the first output amplifier 111 and the other terminal to which the first reference voltage VH_REF is applied. The second switch SW2 may have one terminal connected to the input IN2 of the second output amplifier 112 and the other terminal to which the first reference voltage VH_REF is applied. The third switch SW3 may have one terminal connected to the input IN1 of the first output amplifier 111 and the other terminal to which the second reference voltage VL_REF is applied. The fourth switch SW4 may have one terminal connected to the input IN2 of the second output amplifier 112 and the other terminal to which the second reference voltage VL_REF is applied. The first switch SW1 and the fourth switch SW4 may be turned on in response to a first enable signal EN1, and the second switch SW2 and the third switch SW3 may be turned on in response to a second enable signal EN2.

Referring to FIGS. 9 and 10, upon a polarity change, the first enable signal EN1 and the second enable signal EN2 may be alternately activated during the first period T1. When the polarity signal POL is changed from a logic low state to a logic high state, the first enable signal EN1 may be activated during the first period T1. When the polarity signal POL is changed from a logic high state to a logic low state, the second enable signal EN2 may be activated during the next first period T1′. As illustrated in FIG. 10, the first enable signal EN1 and the second enable signal EN2 may not be simultaneously activated.

When the state of the polarity signal POL is changed and the first switch SW1 and the fourth switch SW4 are turned on in response to the first enable signal EN1 during the first period T1, the input IN1 of the first output amplifier 111 may be pre-charged to the first reference voltage VH_REF and the input IN2 of the second output amplifier 112 may be pre-charged to the second reference voltage VH_REF.

Thereafter, when the state of the polarity signal POL is changed again and the second switch SW2 and the third switch SW3 are turned on in response to the second enable signal EN2 during the next first period T1′, the input IN1 of the first output amplifier 111 may be pre-charged to the second reference voltage VL_REF and the input IN2 of the second output amplifier 112 may be pre-charged to the first reference voltage VH_REF.

During the first periods T1 and T1′, the multiplexer 140c may stop operating in response to the pre-charge enable signal PC_EN and output no voltage. Thereafter, during the second period T2, the gamma voltages VHx and VLx may be output to the input IN1 of the first output amplifier 111 and the input IN2 of the second output amplifier 112.

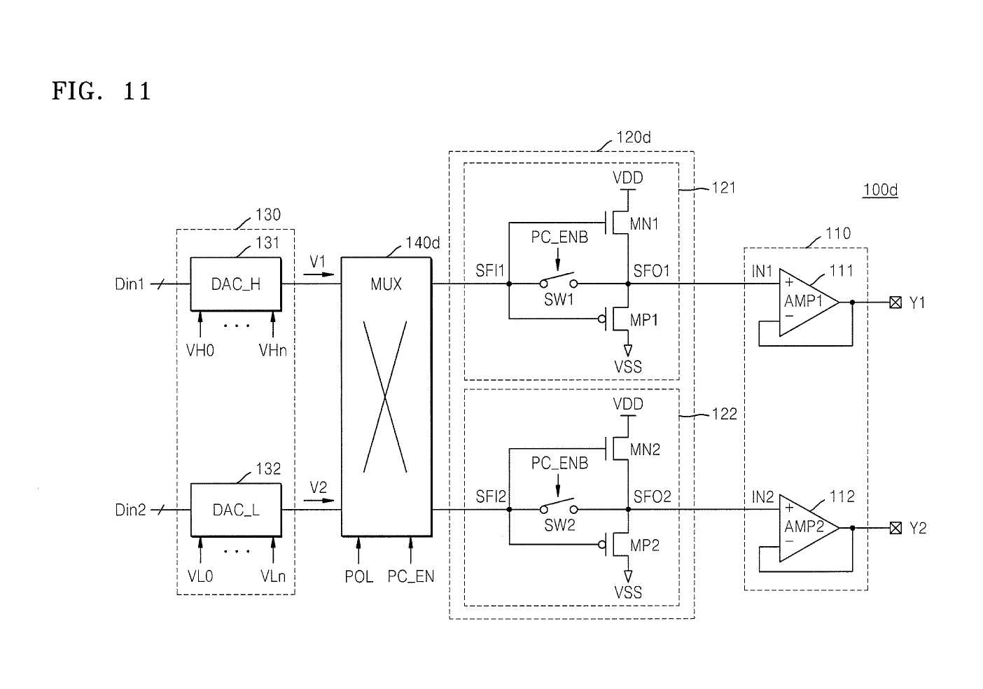

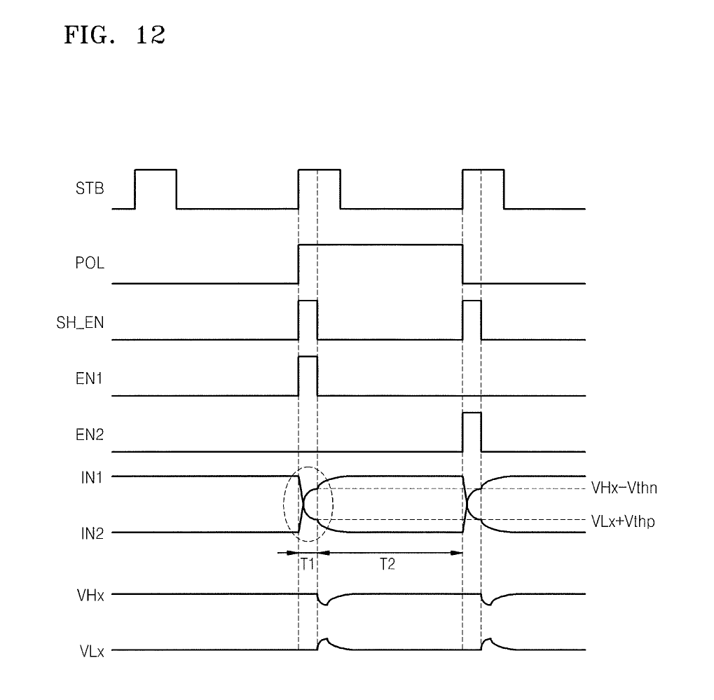

FIG. 11 is a block diagram of a source driver 100d as a modification of the source driver 100 of FIG. 1, and FIG. 12 is a timing diagram of a pre-charge operation of the source driver 100d of FIG. 11.

Referring to FIG. 11, the source driver 100d may include an output unit 110, a pre-charge unit 120d, a DAC unit 130, and a multiplexer 140d. The operations of the output unit 110 and the DAC unit 130 of the source driver 100d of FIG. 11 are substantially the same as those of the output unit 110 and the DAC unit 130 of the source driver 100 of FIG. 1, and thus, a repeated description thereof will be omitted.

The pre-charge unit 120d may include a first pre-charge circuit 121 connected to a first output amplifier 111, and a second pre-charge circuit 122 connected to a second output amplifier 112. The first pre-charge circuit 121 may be connected between an output of the multiplexer 140d and an input IN1 of the first output amplifier 111, and the second pre-charge circuit 122 may be connected between another output of the multiplexer 140d and an input IN2 of the second output amplifier 112.

The first pre-charge circuit 121 may include a first NMOS transistor MN1, a first PMOS transistor MP1, and a first switch SW1. The first NMOS transistor MN1 may have a gate connected to the input SFI1 of the first pre-charge circuit 121, a source connected to the output SFO1 of the first pre-charge circuit 121, and a drain to which a first power supply voltage VDD is applied. The first PMOS transistor MP1 may have a gate connected to the input SFI1 of the first pre-charge circuit 121, a source connected to the output SFO1 of the first pre-charge circuit 121, and a drain to which a second power supply voltage VSS is applied. For example, the second power supply voltage VSS may be a ground voltage. The first switch SW1 may be connected between the input SFI1 and the output SFO1 of the first pre-charge circuit 121, and may be turned on in response to a pre-charge enable bar signal PC_ENB.

The second pre-charge circuit 122 may have a similar structure to the first pre-charge circuit 121. The second pre-charge circuit 122 may include a second NMOS transistor MN2, a second PMOS transistor MP2, and a second switch SW2. The second NMOS transistor MN2 may have a gate connected to an input SFI2 of the second pre-charge circuit 122, a source connected to an output SFO2 of the second pre-charge circuit 122, and a drain to which the first power supply voltage VDD is applied. The second PMOS transistor MP2 may have a gate connected to the input SFI2 of the second pre-charge circuit 122, a source connected to the output SFO2 of the second pre-charge circuit 122, and a drain to which the second power supply voltage VSS is applied. For example, the second power supply voltage VSS may be a ground voltage. The second switch SW2 may be connected between the input SFI2 and the output SFO2 of the second pre-charge circuit 122, and may be turned on in response to the pre-charge enable bar signal PC_ENB.

The first NMOS transistor MN1 and the first PMOS transistor MP1 of the first pre-charge circuit 121, and the second NMOS transistor MN2 and the second PMOS transistor MP2 of the second pre-charge circuit 122 may operate as a source follower.

Referring to FIGS. 11 and 12, when the state of the polarity signal POL is changed, the pre-charge enable bar signal PC_ENB may be deactivated during the first period T1, and the first switch SW1 may be turned off. When the input IN1 of the first output amplifier 111 changes from the first gamma voltage VHx to the second gamma voltage VLx, the multiplexer 140d may provide the second gamma voltage VLx to the input IN1 of the first output amplifier 111. At this time, since the first switch SW1 is turned off during the first period T1, the second gamma voltage VLx may be applied to the input SFI1 of the first pre-charge circuit 121.

Since the input SFI1 of the first pre-charge circuit 121 is lower than the output SFO1 of the first pre-charge circuit 121, the first PMOS transistor MP1 may be turned on. Therefore, the first pre-charge circuit 121 may operate as a source follower. The output SFO1 of the first pre-charge circuit 121 may follow the input SFI1 of the first pre-charge circuit 121. The output SFO1 of the first pre-charge circuit 121 and the input IN1 of the first output amplifier 111 may be pre-charged to a voltage level VLx+Vthp that is higher than a voltage level of the second gamma voltage VLx by a threshold voltage Vthp of the first PMOS transistor MP1. During the second period T2 that is subsequent to the first period T1, the pre-charge enable bar signal PC_ENB may be activated, and the first switch SW1 may be turned on. The second gamma voltage VLx that is output from the multiplexer 140d may be applied to the input IN1 of the first output amplifier 111.

When the input IN1 of the first output amplifier 111 changes from the second gamma voltage VLx to the first gamma voltage VHx, the multiplexer 140d may provide the first gamma voltage VHx to the input IN1 of the first output amplifier 111. At this time, since the first switch SW1 is turned off during the first period T1, for example, the pre-charge period, the first gamma voltage VHx may be applied to the input SFI1 of the first pre-charge circuit 121.

Since the input SFI1 of the first pre-charge circuit 121 is higher than the output SFO1 of the first pre-charge circuit 121, the first NMOS transistor MN1 may be turned on. Therefore, the first pre-charge circuit 121 may operate as a source follower. The output SFO1 of the first pre-charge circuit 121 may follow the input SFI1 of the first pre-charge circuit 121.

Since the output SFO1 of the first pre-charge circuit 121 is connected to the input IN1 of the first output amplifier 111, the input IN1 of the first output amplifier 111 may be pre-charged to a voltage level VHx−Vthn that is lower than a voltage level of the first gamma voltage VHx by a threshold voltage Vthn of the first NMOS transistor MN1. During the second period T2 that is subsequent to the first period T1, the pre-charge enable bar signal PC_ENB may be activated and the first switch SW1 may be turned on. The first gamma voltage VHx that is output from the multiplexer 140d may be applied to the input IN1 of the first output amplifier 111.

The operation of the second pre-charge circuit 122 is substantially the same as the operation of the first pre-charge circuit 121, and thus, a detailed description thereof will be omitted. As described above, upon a polarity change, the pre-charge unit 120d of the source driver 100d of FIG. 11 may operate as the source follower during the first period T1. Thus, the input IN1 of the first output amplifier 111 and the input IN2 of the second output amplifier 112 may be pre-charged to a similar voltage level to a voltage level of the applied gamma voltage.

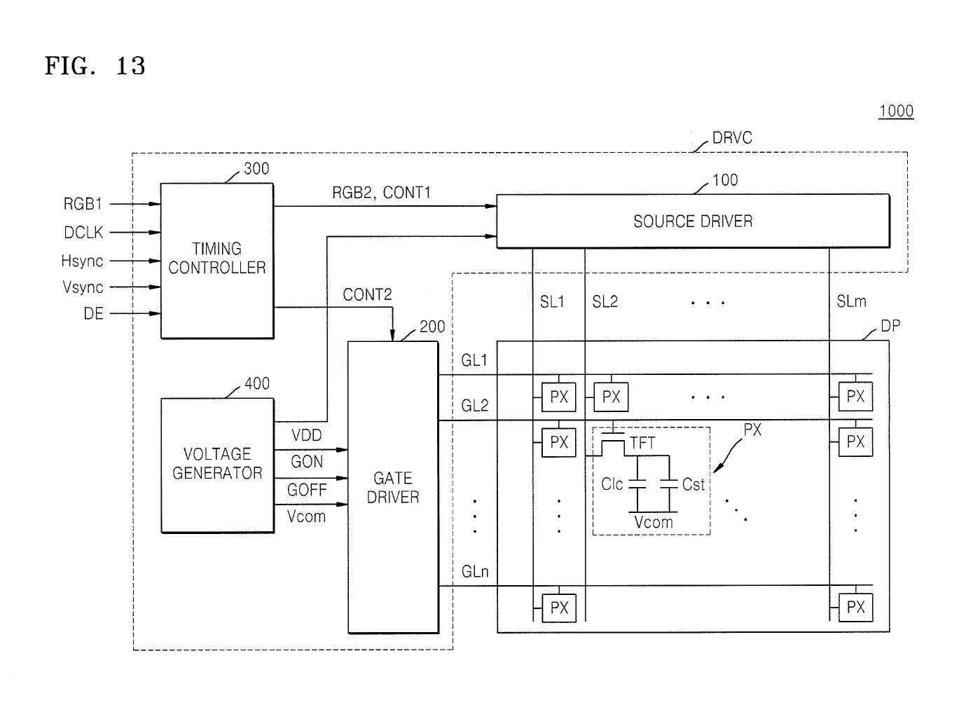

FIG. 13 is a block diagram of a display device 1000 according to an embodiment of the present disclosure. Referring to FIG. 13, the display device 1000 may include a display panel DP and a driver circuit DRVC.

The display panel DP may display an image in units of frames. Examples of the display panel DP may include a liquid crystal display (LCD), a light-emitting diode (LED) display, an organic LED (OLED) display, an active-matrix OLED (AMOLED) display, a flexible display, and other types of flat panel displays. For convenience, a case that the display panel DP is a liquid crystal display panel will be described below.

The display panel DP may include a plurality of gate lines GL1 to GLn arranged in a row direction, a plurality of source lines SL1 to SLm arranged in a column direction, and a plurality of pixels PX arranged at intersections of the gate lines GL1 to GLn and the source lines. As illustrated in FIG. 13, a pixel PX in the display panel DP (in particular, the liquid crystal display panel) may include a thin film transistor TFT, a liquid crystal capacitor Clc and a storage capacitor Cst. The liquid crystal capacitor Clc and the storage capacitor Cst may be connected to a drain of the thin film transistor TFT. A common voltage Vcom may be connected to the other terminals of the liquid crystal capacitor Clc and the storage capacitor Cst.

When the gate lines GL1 to GLn are sequentially scanned, the thin film transistors TFT of the pixels PX connected to a selected gate line may be turned on, and gamma voltages corresponding to data RGB2 of the pixels may be applied to the source lines SL1 to SLm, respectively. The gamma voltage may be applied to the liquid crystal capacitor Clc and the storage capacitor Cst through the thin film transistor TFT of the relevant pixel PX, and the liquid crystal capacitor Clc and the storage capacitor Cst may be driven. In this manner, the display operation is performed.

The driver circuit DRVC may include a source driver 100, a gate driver 200, a timing controller 300, and a voltage generator 400. The driver circuit DRVC may be implemented using a single semiconductor chip or a plurality of semiconductor chips.

The timing controller 300 may receive image data RGB1, a horizontal synchronization signal Hsync, a vertical synchronization signal Vsync, a clock signal DCLK, and a data enable signal DE from an external device (for example, a host device (not illustrated)), and may generate control signals CNT1 and CNT2 for controlling the gate driver 200 and the source driver 100, based on the received data and signals. In addition, the timing controller 300 may generate pixel data RGB2 by converting the image data RGB1 into a format complying with an interface specification of the source driver 100, and may transmit the pixel data RGB2 to the source driver 100.

The gate driver 200 and the source driver 100 may drive the pixels PX of the display panel DP according to the control signals CNT1 and CNT2 provided by the timing controller 300.

The source driver 100 may drive the source lines SL1 to SLm of the display panel DP according to the control signal CNT1. The source driver 100 may generate a plurality of gamma voltages, and may output gamma voltages corresponding to the pixel data RGB2 to the source lines SL1 to SLm of the display panel DP. In the present example, the source drivers 100 and 100′ of FIGS. 1 and 2 may be applied as the source driver 100. The source driver 100 may include the pre-charge unit or blocks (120 of FIG. 1, or 121 to 12k of FIG. 2). Upon a polarity change, the source driver 100 may pre-charge the inputs of the output amplifiers (111 and 112 of FIG. 1, or 111 to 11n of FIG. 2).

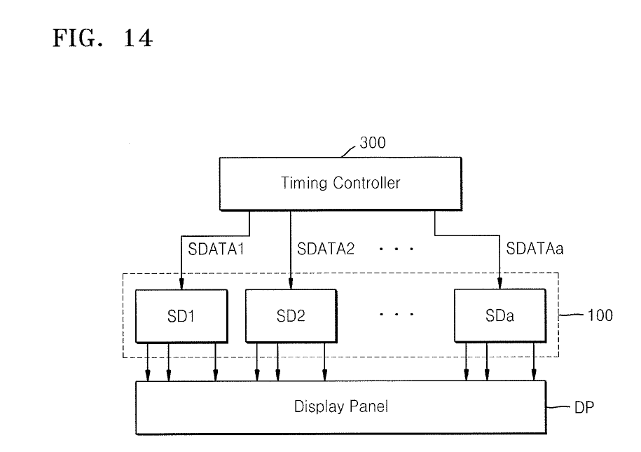

On the other hand, the source driver 100 may be implemented using a single chip, or may be implemented using a plurality of source driver chips SD1 to SDa, as illustrated in FIG. 14. In this case, the timing controller 300 may divide the image data RGB1 into a plurality of pieces of source data SDATA1 to SDATAa according to regions of the display panel DP that are driven by the respective source driver chips SD1 to SDa, and may transmit the plurality of pieces of source data SDATA1 to SDATAa to the relevant source driver chips SD1 to SDa.

The gate driver 200 may sequentially scan the gate lines GL1 to GLn of the display panel DP. The gate driver 200 may activate a selected gate line by applying a gate-on voltage GON to the selected gate line, and the source driver 100 may output the relevant gamma voltages to the pixels connected to the activated gate line. In this manner, an image may be displayed on the basis of a single horizontal line, that is, row-by-row.

The voltage generator 400 may generate voltages that are used in the driver circuit DRVC and the display panel DP. The voltage generator 400 may generate the gate-on voltage GON, a gate-off voltage GOFF, a common voltage Vcom, and a first power supply voltage VDD. The gate-on voltage GON and the gate-off voltage GOFF may be provided to the gate driver 200, and may be used to generate gate signals that are applied to the gate lines G1 to Gn. The common voltage Vcom may be commonly provided to the pixels PX of the display panel DP. As described in FIG. 13, the common voltage Vcom may be provided to one terminal of the liquid crystal capacitor Clc and one terminal of the storage capacitor Cst. The first power supply voltage VDD may be used during the operation of the source driver 100.

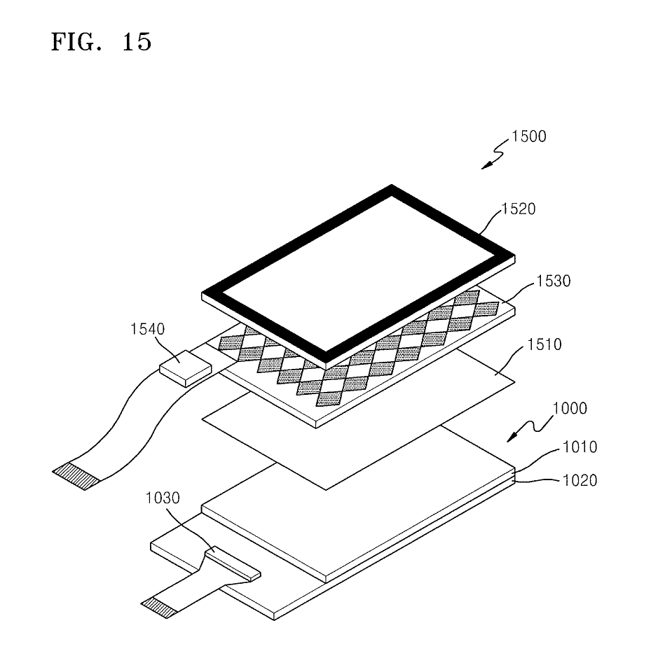

FIG. 15 is a schematic diagram of a display module 1500 according to an embodiment of the present disclosure. Referring to FIG. 15, the display module 1500 may include a display device 1000, a polarizing plate 1510, and a window glass 1520. The display device 1000 may include a display panel 1010, a printed circuit board 1020, and a display driver integrated circuit 1030.

The window glass 1520 may be made of acryl or tempered glass. The window glass 1520 may protect the display module 1500 from external impact or scratches caused by repeated touches. The polarizing plate 1510 may be provided so as to improve optical characteristics of the display panel 1010. The display panel 1010 may include transparent electrodes patterned on the printed circuit board 1020. The display panel 1010 may include a plurality of pixels for displaying a frame. According to an embodiment, the display panel 1010 may be a liquid crystal panel. However, the display panel 1010 is not limited to the liquid crystal panel and may include various types of display devices. For example, the display panel 1010 may be one selected from an OLED, an electrochromic display (ECD), a digital mirror device (DMD), an actuated mirror device (AMD), a grating light value (GLV), a plasma display panel (PDP), an electro luminescent display (ELD), an LED display, and a vacuum fluorescent display (VFD).

The display driver integrated circuit 1030 may include a source driver (100 of FIG. 1, or 100′ of FIG. 2) according to the embodiments of the present disclosure.

In the present embodiment, the display driver integrated circuit 1030 is illustrated as being a single chip, but this is only for convenience of illustration. The display driver integrated circuit 1030 may be provided as a plurality of chips. In addition, the display driver integrated circuit 1030 may be mounted on the printed circuit board 1020 by a chip-on-glass (COG) method. However, this is merely exemplary, and the display driver integrated circuit 1030 may be mounted by various methods, for example, a chip-on-film (COF) method or a chip-on-board (COB) method.

The display module 1500 may further include a touch panel 1530 and a touch controller 1540. The touch panel 1530 may include transparent electrodes, such as indium tin oxide (ITO), which are patterned on a glass substrate or a polyethylene terephthalate (PET) film. The touch controller 1540 may sense a touch on the touch panel 1530, calculate coordinates of a touch point, and transmit the calculated coordinates of the touch point to a host (not illustrated). The touch controller 1540 may be integrated into a single semiconductor chip together with the display driver integrated circuit 1030.

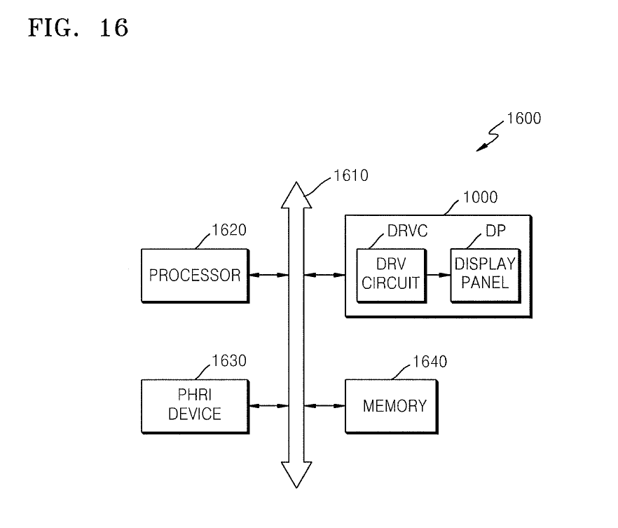

FIG. 16 is a block diagram of a display system 1600 according to an embodiment of the present disclosure. Referring to FIG. 16, the display system 1600 may include a processor 1620, a display device 1000, a peripheral device 1630, and a memory 1640, which are electrically connected to a system bus 1610.

The processor 1620 may control data input/output of the peripheral device 1630, the memory 1640 and the display device 1000, and may perform image processing on image data that is transmitted among the devices. The display device 1000 may include a display panel DP and a display driver integrated circuit DRVC. The display device 1000 may store image data, which is input through the system bus 1610, in a frame memory or a line memory included in the display driver integrated circuit DRVC, and may display the stored image data on a display panel DP. The display device 1000 may be the display device 1000 of FIG. 13, and the display driver integrated circuit DRVC may include a source driver (100 of FIG. 1, or 100′ of FIG. 2) according to the embodiments of the present disclosure.

The peripheral device 1630 may be a device, such as a camera, a scanner, or a webcam, which converts a moving picture or a still image into an electric signal. Image data acquired through the peripheral device 1630 may be stored in the memory 1640, or may be displayed on the panel of the display device 1000 in real time. The memory 1640 may include a volatile memory device, such as a dynamic random access memory (DRAM), and/or a non-volatile memory device, such as a flash memory. Examples of the memory 2840 may include a DRAM, a phase-change RAM (PRAM), a magnetic RAM (MRAM), a resistive RAM (ReRAM), a ferroelectric RAM (FRAM), a NOR flash memory, a NAND flash memory, and a fusion flash memory (for example, a memory in which an SRAM buffer, a NAND flash memory, and a NOR interface logic are combined). The memory 1640 may store image data acquired through the peripheral device 1630, or may store image signals processed by the processor 1620.

The display system 1600 according to the embodiment of the present disclosure may include consumer electronics, such as a tablet personal computer (PC) or a television. However, the display system 1600 is not limited thereto. The display system 1600 may include various types of electric devices that display an image.

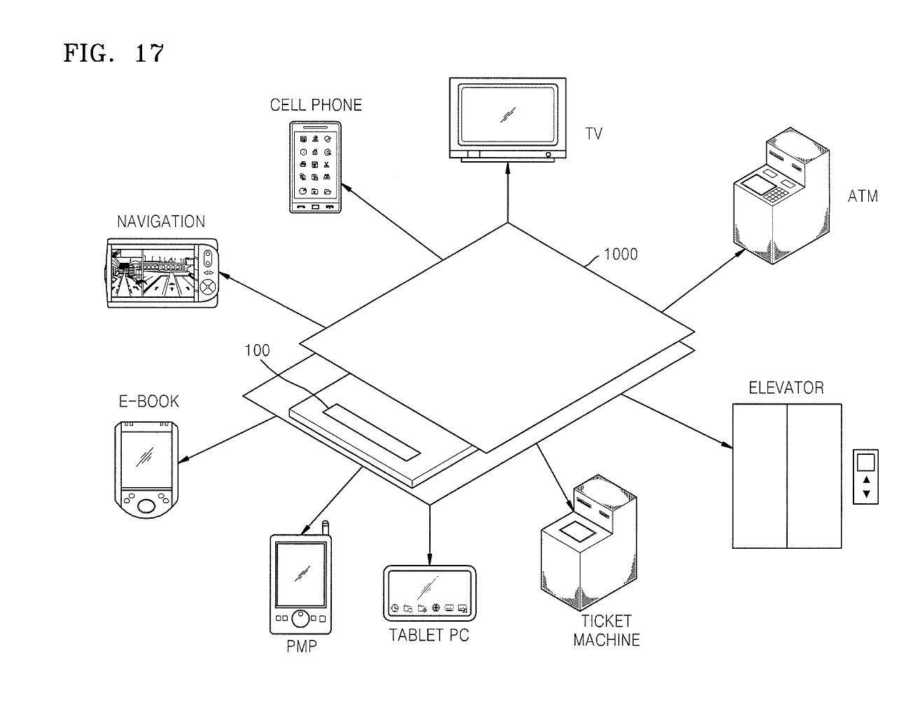

FIG. 17 is a schematic diagram illustrating examples of various electrical systems on which the display devices according to the embodiments of the present disclosure are mounted. The display device 1000 according to the embodiment of the present disclosure may adopt various types of electronic appliances. The display device 1000 according to the embodiment of the present disclosure may be widely used in, for example, a mobile phone, a television, an automated teller machine (ATM) that automatically performs bank transactions, an elevator, a ticket dispenser in a subway station or the like, a portable multimedia player (PMP), an e-book, a navigation system, and a tablet PC.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A source driver, comprising:
an output circuit including a first output amplifier to output a first output voltage and a second output amplifier to output a second output voltage, a polarity of the second output voltage being opposite to a polarity of the first output voltage;
a pre-charge circuit to pre-charge an input of the first output amplifier and an input of the second output amplifier during a first period, upon a polarity change of the output circuit;
a digital-to-analog conversion (DAC) including a first converter and a second converter, the first converter being to receive first input data and output a first voltage, and the second converter to receive second input data and output a second voltage; and
a multiplexer to selectively provide the first output amplifier and the second output amplifier with the first voltage and the second voltage.

2. The source driver of claim 1, wherein the source driver is to apply gamma voltages corresponding to the first output amplifier and the second output amplifier to the input of the first output amplifier and the input of the second output amplifier during a second period subsequent to the first period.

3. The source driver of claim 1, wherein:
the first converter is to select the first voltage among a plurality of first gamma voltages based on the first input data,
the second converter is to select the second voltage among a plurality of second gamma voltages based on the second input data,
a polarity of the plurality of second gamma voltages is opposite to a polarity of the plurality of first gamma voltages, and
the multiplexer is to selectively provide the first voltage to one of the input of the first output amplifier and the input of the second output amplifier, and to selectively provide the second voltage to the other of the input the first output amplifier and the input of the second output amplifier, in responsive to a polarity signal.

4. The source driver of claim 1, wherein the pre-charge circuit is to perform charge sharing by connecting the input of the first output amplifier to the input of the second output amplifier during the first period.

5. The source driver of claim 1, wherein the pre-charge circuit includes a switch that is connected between the input of the first output amplifier and the input of the second output amplifier and is turned on in response to a pre-charge enable signal during the first period.

6. The source driver of claim 1, wherein the pre-charge circuit is to apply a predetermined voltage to the input of the first output amplifier and the input of the second output amplifier during the first period.

7. The source driver of claim 1, wherein the pre-charge circuit includes:
a first switch having one terminal connected to the input of the first output amplifier and another terminal to which a common voltage is applied; and
a second switch having one terminal connected to the input of the second output amplifier and another terminal to which the common voltage is applied, the first switch and the second switch being turned on in response to a pre-charge enable signal during the first period.

8. The source driver of claim 1, wherein the pre-charge circuit includes:
a first switch having one terminal connected to the input of the first output amplifier and another terminal to which a first reference voltage is applied;
a second switch having one terminal connected to the input of the second output amplifier and another terminal to which the first reference voltage is applied;
a third switch having one terminal connected to the input of the first output amplifier and another terminal to which a second reference voltage is applied; and
a fourth switch having one terminal connected to the input of the second output amplifier and another terminal to which the second reference voltage is applied, the first switch and the fourth switch being turned on in response to a first enable signal, the second switch and the third switch being turned on in response to a second enable signal.

9. The source driver of claim 8, wherein the first enable signal and the second enable signal are alternately activated during the first period upon the polarity change of the output circuit.

10. The source driver of claim 1, wherein the pre-charge circuit includes:
a first pre-charge circuit to pre-charge the input of the first output amplifier; and
a second pre-charge circuit to pre-charge the input of the second output amplifier, wherein the first pre-charge circuit and the second pre-charge circuit apply a voltage, which is higher or lower than a received input voltage by a threshold voltage, to the input of the first output amplifier and the input of the second output amplifier during the first period, and apply the received input voltage to the input of the first output amplifier and the input of the second output amplifier during a second period subsequent to the first period.

11. The source driver of claim 10, wherein the first pre-charge circuit includes:
an NMOS transistor having a gate connected to an input of the first pre-charge circuit, a drain to which a first power supply voltage is applied, and a source connected to an output of the first pre-charge circuit;
a PMOS transistor having a gate connected to the input of the first pre-charge circuit, a drain to which a second power supply voltage is applied, and a source connected to the output of the first pre-charge circuit; and
a switch that is connected between the input and the output of the first pre-charge circuit, wherein one of the PMOS transistor or the NMOS transistor operates as a source follower during the first period, and wherein the switch is turned on during the second period to output the received input voltage.

12. A source driver, comprising:
a gamma voltage generation circuit including a first resistor string and a second resistor string, the gamma voltage generation circuit to generate a plurality of first gamma voltages and a plurality of second gamma voltages, a polarity of the plurality of second gamma voltages being different from a polarity of the plurality of first gamma voltages;
a digital-to-analog conversion circuit to select gamma voltages among the plurality of first gamma voltages and the plurality of second gamma voltages, based on input data and a polarity signal;
an output circuit including a plurality of output amplifiers to receive the selected gamma voltages and to buffer the received gamma voltages, the plurality of output amplifiers output the buffered gamma voltages to source lines of a display panel, the output circuit to output voltages of different polarities; and
a pre-charge circuit to pre-charge inputs of the plurality of output amplifiers upon a polarity change of the output circuit.

13. The source driver of claim 12, wherein the pre-charge circuit is to pre-charge the inputs of the plurality of output amplifiers during a first period and to apply the selected gamma voltages to the inputs of the plurality of output amplifiers during a second period subsequent to the first period.

14. The source driver of claim 13, wherein the pre-charge circuit is to connect inputs of at least two output amplifiers that output voltages of different polarities among the plurality of output amplifiers during the first period.

15. The source driver of claim 13, wherein the pre-charge circuit is to apply at least one reference voltage to the inputs of the plurality of output amplifiers during the first period.

16. The source driver of claim 15, wherein the at least one reference voltage has a voltage level between the plurality of first gamma voltages and the plurality of second gamma voltages.

17. A portable electronic device, comprising:
a processor;
a memory; and
a display device including a display panel and a driver circuit, the display panel to display an image, the driver circuit including:
a timing controller to receive image data and to convert the image data into pixel data;
a voltage generator to generate voltages that are used in the driver circuit and the display panel; and
a source driver which includes:
an output circuit including a first output amplifier to output a first output voltage and a second output amplifier to output a second output voltage, a polarity of the second output voltage being opposite to a polarity of the first output voltage;
a pre-charge circuit to pre-charge an input of the first output amplifier and an input of the second output amplifier during a first period, upon a polarity change of the output circuit.

18. The portable electronic device of claim 17, wherein the source driver includes:
a digital-to-analog conversion (DAC) including a first converter and a second converter, the first converter to receive first input data and output a first voltage, the second converter to receive second input data and output a second voltage; and
a multiplexer to selectively provide the first output amplifier and the second output amplifier with the first voltage and the second voltage.

19. The portable electronic device of claim 17, wherein the source driver is to apply gamma voltages corresponding to the first output amplifier and the second output amplifier to the input of the first output amplifier and the input of the second output amplifier during a second period subsequent to the first period.

20. The portable electronic device of claim 17, wherein the driver circuit includes a gate driver to sequentially scan gate lines of the display panel and to activate a selected gate line by applying a gate-on voltage to the selected gate line.
